(19) United States
(12) Patent Application Publication
(10) Pub. No.: US 2009/0254598 A1
(43) Pub. Date: Oct. 8, 2009

(54) Folding of Input Data Values to a Transform Function

(76) Inventors: Jim Svensson, Lund (SE); Thomas Olsson, Karlshamm (SE); Leif Wilhelmsson, Dalby (SE)

Correspondence Address: POTOMAC PATENT GROUP PLLC, P. O. BOX 270, FREDERICKSBURG, VA, 22404, US

(21) Appl. No.: 12/307,351

(22) PCT Filed: Jul. 6, 2007
(86) PCT No.: PCT/EP07/06002

§ 371 Date: Apr. 8, 2009

Related U.S. Application Data
(60) Provisional application No. 60/807,634, filed on Jul. 18, 2006.

(30) Foreign Application Priority Data
Jul. 18, 2006 (EP) 06388052.0

(51) Int. Cl. G06F 17/14

(52) U.S. Cl. 708/404; 708/405; 708/409

(57) ABSTRACT

A method of processing a set of input data values comprises the steps of providing said input data values serially to circuitry comprising a number of memory elements; and performing in said circuitry a transform function to obtain a set of transformed data values. The method further comprises the steps of delaying a subset of said set of input data values under use of said memory elements; providing a modified set of data values by adding individual delayed data values to individual non-delayed data values from said set of input data values; and performing said transform function on said modified set of data values. In this way a transform function can be evaluated at fewer output data values than available input data values without increasing the memory requirements considerably.

### TECHNICAL FIELD OF THE INVENTION

The invention relates to a method of processing a set of input data values, the method comprising the steps of providing said input data values serially to circuitry comprising a number of memory elements; and performing in said circuitry a transform function to obtain a set of transformed data values. The invention further relates to a device for processing a set of input data values with circuitry arranged to receive said input data values serially and perform a transform function to obtain a set of transformed data values, and to a corresponding computer program and computer readable medium.

### BACKGROUND

Transform functions of different types are often used in the processing of data values. As an example, the Discrete Fourier Transform (DFT) is a versatile tool in the field of signal processing, communication and related areas. While the non discrete Fourier Transform (FT) is used to produce the whole spectral content of a signal for a continuum of frequencies the DFT evaluates the spectral content for a discrete set of frequencies, hence its name. Similarly, corresponding inverse functions, such as the Inverse DFT, are frequently used in these fields.

In software and hardware implementations of DFTs the calculations are typically organized according to a certain class of methods so as to reduce the number of costly operations such as multiplication. A DFT implementation derived in this manner is called a Fast Fourier Transform (FFT). When FFTs are implemented in hardware it is frequently in a pipelined style where the data flow through a number of stages, the data successively being modified until all required operations have been executed in a satisfactory order. The same implementations can be used for the Inverse Fast Fourier Transform (IFFT). Different architectures for pipeline FFT processors are known from e.g. U.S. Pat. No. 6,098,088.

Typically, the number of transformed data values is equal to or larger than the number of input data values. Thus e.g. for a DFT the number of frequencies to evaluate the spectrum at is typically equal to or larger than the number of data samples on which the DFT is applied. There are, however, certain conditions for which it is of interest to evaluate the Fourier Transform at fewer frequencies than available data samples. A class of conditions for which this might be the case is when the useful contents of the data to transform are known to be periodic. Due to the limited frequency content of the useful part of the signal it would then be unnecessary and maybe even undesirable to evaluate the FT at more frequencies than the number of data samples in one period. A specific example is when a DFT is used for demodulation of Orthogonal Frequency Division Multiplexing (OFDM) type of signals. In this case extra data samples can be used to reduce noise and Inter Carrier Interference (ICI).

While using a pipelined FFT to evaluate a DFT for more frequency points than data samples is easy and only requires extra zero valued samples to be inserted after (and/or before) the actual data, the other case, i.e. evaluating the transform at fewer frequencies than available data samples, is less straight-forward. One solution could be to use an FFT of the size corresponding to the number of input data samples and then just disregard some of the evaluated frequency points, but that would normally not allow the remaining frequency points to be optimally placed (e.g. equidistantly) over the intended range. Further, the use of a larger FFT means that the memory requirements are increased considerably, which is a disadvantage, especially in portable equipment where memory is a scarce resource. The same problems exist for a pipelined IFFT.

Therefore, it is an object of the invention to provide a method and a device in which a transform function can be evaluated at fewer output data values than available input data values without increasing the memory requirements considerably.

### SUMMARY

According to the invention the object is achieved in that the method further comprises the steps of delaying a subset of said set of input data values under use of said memory elements; providing a modified set of data values by adding individual delayed data values to individual non-delayed data values from said set of input data values; and performing said transform function on said modified set of data values. By providing a modified set of data values, which is smaller (i.e. contains fewer data values) than the original set of input data values, a transform function of smaller size can be used, and further the memory requirements are reduced when the memory elements already present in the transform circuitry are re-used for delaying the subset of the input values as described.

In one embodiment the transform function is a Fast Fourier Transform. Alternatively, the transform function may be an Inverse Fast Fourier Transform.

When the transform function is performed using a pipelined architecture in a number of serially connected stages in said circuitry, each stage comprising a butterfly unit and a number of memory elements, the re-use of the memory elements in the stages of the transform circuitry for delaying some of the input data values will reduce the memory requirements considerably.

In one embodiment, the memory elements of each stage constitute a First In First Out buffer.

When the method further comprises providing the modified set of data values to have the same size as the set of transformed data values, the circuitry and the memory requirements can be further reduced. In that case, the method may further comprise the step of delaying the subset of data values in one delay element in addition to the memory elements comprised in said circuitry. In one embodiment, the method may further comprise the step of multiplying the set of input data values by a window function. Alternatively, the modified set of data values may be multiplied by the window function. The use of a window function might be useful e.g. in reception of OFDM signals, where the number of samples in the window function is typically higher than the size of the DFT.

As mentioned, the invention also relates to a device for processing a set of input data values, the device comprising circuitry arranged to receive said input data values serially and perform a transform function to obtain a set of transformed data values, said circuitry comprising a number of memory elements. When the device is further arranged to delay a subset of said set of input data values under use of said memory elements; provide a modified set of data values by adding individual delayed data values to individual non-delayed data values from said set of input data values; and perform said transform function on said modified set of data values, a modified set of data values, which is smaller than the original set of input data values can be provided, and a transform function of smaller size can be used. Further, the memory requirements are reduced when the memory elements already present in the transform circuitry can be re-used for delaying the subset of the input values as described.

In one embodiment the transform function is a Fast Fourier Transform. Alternatively, the transform function may be an Inverse Fast Fourier Transform.

When the circuitry for performing said transform function has a pipelined architecture with a number of serially connected stages, each stage comprising a butterfly unit and a number of memory elements, the re-use of the memory elements in the stages of the transform circuitry for delaying some of the input data values will reduce the memory requirements considerably.

In one embodiment, the memory elements of each stage constitute a First In First Out buffer.

When the device is arranged to provide the modified set of data values to have the same size as the set of transformed data values, the circuitry and the memory requirements can be further reduced. In that case, the device may further comprise one delay element arranged to delay the subset of data values in addition to the memory elements comprised in said circuitry.

In one embodiment, the device may further be arranged to multiply the set of input data values by a window function. Alternatively, the modified set of data values may be multiplied by the window function. The use of a window function might be useful e.g. in reception of OFDM signals, where the number of samples in the window function is typically higher than the size of the DFT.

The circuitry may further comprise a number of butterfly units, each butterfly unit having at least a shift mode and a computation mode; and a number of counters arranged such that the mode of each butterfly unit is controlled by the output of a counter. This provides an efficient control of the circuitry.

The device may further comprise circuitry for demodulation of Orthogonal Frequency Division Multiplexing signals.

The invention also relates to a computer program and a computer readable medium with program code means for performing the method described above.

### BRIEF DESCRIPTION OF THE DRAWINGS

The invention will now be described more fully below with reference to the drawings, in which

FIG. 1 shows a Discrete Fourier Transform of size 8,

FIG. 2 shows a Discrete Fourier Transform of size 8 decomposed into two Discrete Fourier Transforms of size 4,

FIG. 3 shows a complete data flow graph of a Discrete Fourier Transform of size 8,

FIG. 4 shows a basic butterfly operation of a Discrete Fourier Transform,

FIG. 5 shows another decomposition of a Discrete Fourier Transform of size 8 into two Discrete Fourier Transforms of size 4,

FIG. 6 shows another complete data flow graph of a Discrete Fourier Transform of size 8,

FIG. 7 shows another basic butterfly operation of a Discrete Fourier Transform,

FIG. 8 shows a pipelined Discrete Fourier Transform of size 8,

FIG. 9 shows a pipelined Discrete Fourier Transform of size 8 with folding of some time domain samples,

FIG. 10 shows the circuitry of FIG. 9 with control by counters, and

FIG. 11 shows an example of windowing with folding.

### DETAILED DESCRIPTION OF EMBODIMENTS

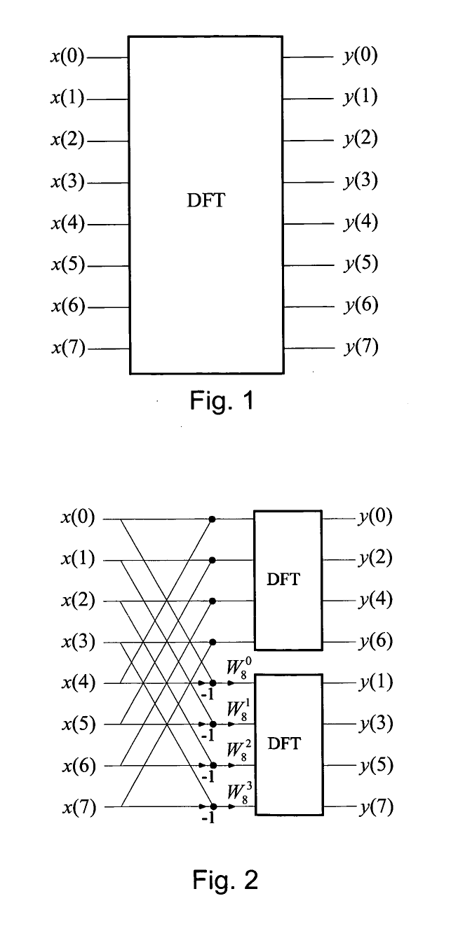

FIG. 1 illustrates a Discrete Fourier Transform (DFT) of size N. Typically, the DFT will have N inputs as well as N outputs, and N=2^{M}, where M is an integer, but as will be seen in the following, this need not be the case in all situations. It is noted that the figure could just as well illustrate an inverse DFT. In FIG. 1 a DFT with N=8 is shown. While no actual relations to neither time nor frequency need to exist, in the examples described below and relating to a DFT the data values or data samples to be transformed will be referred to as time (domain) data x(n) whereas the transformed data will be called frequency (domain) data and written as y(•).

For the (not discrete) Fourier Transform the frequency domain data is defined as

$$y ( f ) = {\sum }_{n} x ( n ) {e}^{- j2π fn} , \qquad ( 1 )$$

where n ranges over the non zero time domain samples and f is the continuous frequency variable.

For a size-N DFT the 1-periodic function y(f) is evaluated for N equidistant frequency points by letting f=k/N for a succession of N integers of k. Then

$$y ( k ) = {\sum }_{n} x ( n ) {e}^{- j2π \frac{1}{N} kn} . \qquad ( 2 )$$

To simplify notation, the so called Twiddle Factor W_{N} is defined as

$${W}_{N} = {e}^{- j2π \frac{1}{N}} . \qquad ( 3 )$$

The DFT is then expressed as

$$y ( k ) = {\sum }_{n} x ( n ) {W}_{N}^{kn} . \qquad ( 4 )$$

For a naive direct calculation of a DFT the asymptotic number of operations is about proportional to N². A large class of methods instead achieve complexity of type N log N and a DFT implemented in this way is called a Fast Fourier Transform (FFT). The type called Decimation In Frequency (DIF), which is particularly suitable for hardware implementations, is now derived assuming there are N time domain samples.

The frequency domain samples for even frequency indices k

$$y ( 2 k ) = {\sum }_{n = 0}^{N - 1} x ( n ) {W}_{N}^{2 kn} = {\sum }_{n = 0}^{N - 1} x ( n ) {W}_{N / 2}^{kn} \qquad ( 5 )$$

are considered. As W_{N/2}^{kn} is N/2-periodic in n, the time domain samples N/2 indices apart can be summed first

$$y ( 2 k ) = {\sum }_{n = 0}^{N / 2 - 1} ( x ( n ) + x ( n + N / 2 ) ) {W}_{N / 2}^{kn} . \qquad ( 6 )$$

It is seen that the frequency domain samples for even indices for the original DFT is obtained as all the frequency domain samples of a size-N/2 DFT performed on the time domain data folded to half the length.

Similarly the frequency domain samples for odd frequencies are found to be

$$y ( 2 k + 1 ) = {\sum }_{n = 0}^{N / 2 - 1} [ ( x ( n ) - x ( n + N / 2 ) ) {W}_{N}^{n} ] {W}_{N / 2}^{kn} . \qquad ( 7 )$$

The odd frequency samples of the original DFT are thus all the frequency domain samples from a size-N/2 DFT performed on the original time domain samples folded and multiplied by the time dependent coefficient W_{N}ⁿ.

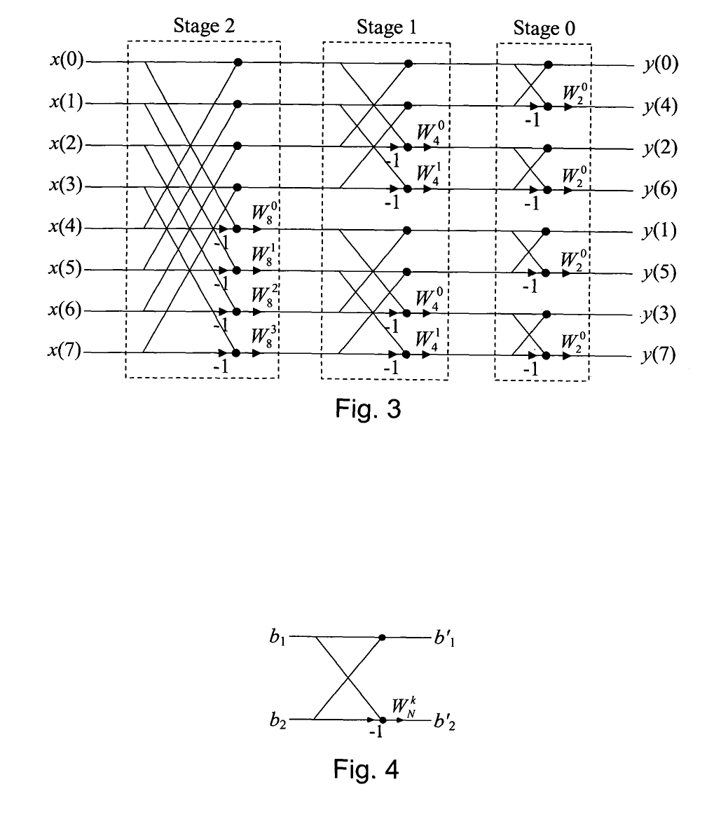

From (6) and (7) it follows that a size-N DFT can be decomposed into two size N/2 DFTs and some extra calculations. The data flow graph of this is shown in FIG. 2. A complete DIF FFT algorithm is obtained by repeated decomposition until all the DFTs are of size N=1, for which y(0)=x(0). This is illustrated in FIG. 3.

In FIG. 3 it is seen that the complete data flow graph is built from many instances of the same basic template shown in FIG. 4. Owing to its shape the template is called a butterfly, and the operation it performs a butterfly operation. The butterfly takes two input samples b₁ and b₂ and by using one addition, one subtraction and one multiplication it produces two output samples b′₁ and b′₂. The only difference between the butterflies is which twiddle factor is used in the multiplication.

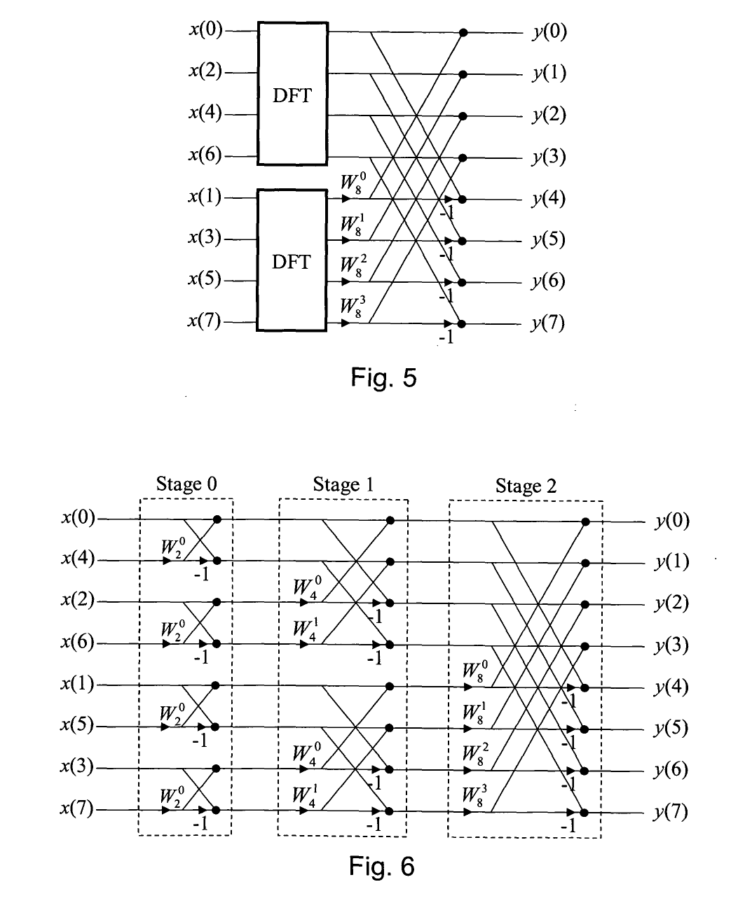

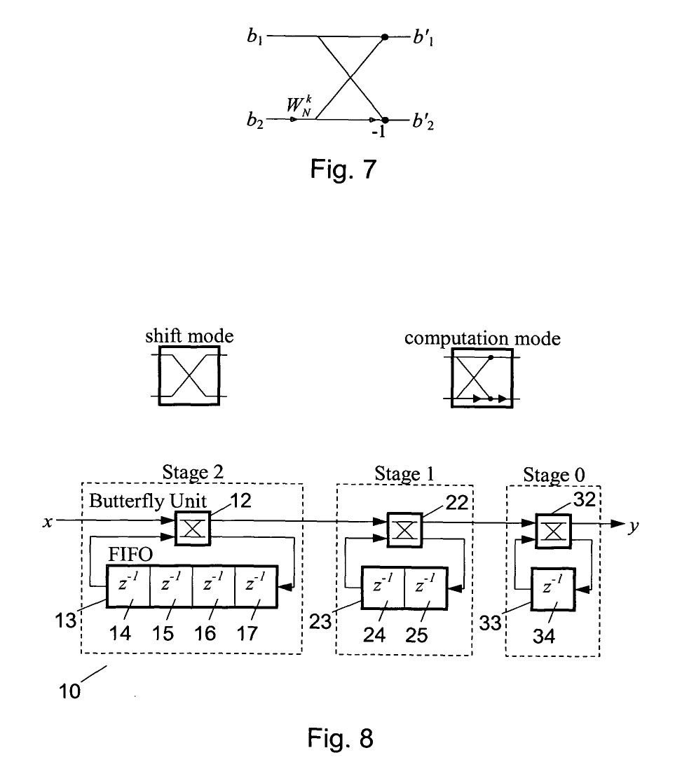

It is noted that the decomposition of a size-N DFT into two size N/2 DFTs and some extra calculations, as an alternative to FIG. 2, can be illustrated as in FIG. 5, in which the two size N/2 DFTs are performed first, followed by the extra calculations. The complete DIF FFT algorithm obtained by repeated decomposition will then be as illustrated in FIG. 6, and the butterfly operation will be as shown in FIG. 7, in which the twiddle factor multiplication is performed in one of the inputs instead of one of the outputs. The following considerations are based on FIGS. 2 to 4, but similar considerations can be made for the butterfly operations of FIGS. 5 to 7 or other similar butterfly configurations.

In FIG. 3 it can be observed that for a size-8 DIF FFT the data flows through log₂(8)=3 stages from left to right, and in each stage 8/2=4 butterfly operations are performed. Thus, a size-N DIF FFT requires a total of (N/2) log₂(N) butterfly operations.

Often the time domain samples arrive serially as x(0), x(1) and so on. In this case it might be desirable to process the samples as they arrive. One way to do this is to calculate all butterfly operations within one stage using only a single butterfly unit with variable twiddle factor. Each stage then receives the samples serially in order (top to bottom in FIG. 3 and pass on the output samples serially top to bottom. If the stages, left to right, are indexed from log2(N)−1 down to 0, then input samples and output samples for every butterfly in stage s are Dₛ=2^{s} indices apart. To produce the required pair of input samples for the butterfly, and to arrange for proper subsequent order of the outputs, stage s is augmented with a First In First Out (FIFO) buffer of size Dₛ.

During operation each stage cyclically repeats two phases. First Dₛ samples are received and placed in the buffer (at the same time the old content of the buffer is read out). In this phase, where no butterfly operations are performed, the stage is said to be in shift mode.

In the second phase the Dₛ samples in the buffer are paired with another Dₛ received samples and used as inputs to the butterfly. One of the outputs from the butterfly is also output from the stage and the second output is saved in the FIFO (to be transmitted during the first phase). In this phase, when butterfly operations are performed, the stage is said to be in computation mode.

The support for the shift mode and the computation mode is collected in a two input two output butterfly unit, which either lets the data pass through or performs the butterfly operation. FIG. 8 illustrates the serial connection of stages, with FIFOs and butterfly units, with constitutes the basis of a pipelined DIF FFT for the size-8 DIF FFT of FIG. 3. The circuitry 10 comprises the three stages, Stage 2, Stage 1 and Stage 0. Stage 2 has the butterfly unit 12 and the FIFO buffer 13 with D₂=2²=4 memory elements 14, 15, 16 and 17. Correspondingly, Stage 1 has the butterfly unit 22 and the FIFO buffer 23 with D₁=2¹=2 memory elements 24 and 25, and Stage 0 has the butterfly unit 32 and the FIFO buffer 33 with D₀=2⁰=1 memory element 34.

As mentioned, the DFT will typically have N inputs as well as N outputs. However, if there are L time domain samples, where L≧N, it follows, since W_{N}^{kn} is N-periodic in n, that

$$y ( k ) = {\sum }_{n = 0}^{N - 1} ( {\sum }_{𝓁} x ( n + 𝓁 N ) ) {W}_{N}^{kn} . \qquad ( 8 )$$

where time domain samples N indices apart are summed first. It seems appropriate to call the inner summation folding of the time domain data. If the time domain data consists of exactly N samples indexed from 0 to N−1 the transform simply becomes

$$y ( k ) = {{\sum }_{n = 0}}^{N - 1} x ( n ) {W}_{N}^{kn} . \qquad ( 9 )$$

This calculation is what one normally means when referring to the DFT, and it is what most hardware and software implementations of the DFT are expected to perform.

From (8) and (9) it is concluded that one way to perform a size-N DFT with L time domain samples and L≧N is to first fold the sequence of time domain samples and then apply a common-or-garden size-N DFT.

Thus one way to calculate a size-N DFT with L time domain samples (L≧N) is to first fold the sequence of time domain samples and then apply a normal size-N DFT. Folding in this context means that every sample is moved within a folding range of N consecutive indices by adding a multiple of N to the original index, and then all samples moved to the same index are summed. From now on the L time domain samples are index as 0≦n<L. Depending on the selected folding range the result will be different, and the difference will be equivalent to a circular shift. An illustration of two different folding ranges with N=8 and L=13 time domain samples is given in Tables 1 and 2.

TABLE 1
Folding indices 0 . . . 12 to range 0 . . . 7

| | | | | | | | | |
|---|---|---|---|---|---|---|---|---|
| | x(8) | x(9) | x(10) | x(11) | x(12) | | | |
| + | x(0) | x(1) | x(2) | x(3) | x(4) | x(5) | x(6) | x(7) |

TABLE 2
Folding indices 0 . . . 12 to range 5 . . . 12

| | | | | | | | | |
|---|---|---|---|---|---|---|---|---|
| | | | | x(0) | x(1) | x(2) | x(3) | x(4) |
| + | x(5) | x(6) | x(7) | x(8) | x(9) | x(10) | x(11) | x(12) |

Table 1 and Table 2 represent two extreme selections for the folding range. In Table 1 the N leftmost (lowest) indices of the time domain samples are selected, and in Table 2 the N rightmost (highest) indices are selected. For a pipelined FFT, where the input samples arrive serially (lower to higher indices) the second alternative is clearly the most attractive as the processing can begin when sample x(5) arrives, and when sample x(8) arrives sample x(0) has arrived earlier and could be available to be added to x(8). The first alternative is less attractive since it would be necessary to wait N samples for sample x(8) to arrive (and then add it with sample x(0)). In general, due to the direction of time, it is more effective to fold to the right, that is, push old samples to the right in steps of N as new samples arrive. The pipelined DIF FFT as described herein has the ability to fold the L-N samples with lowest indices to the range of the N highest indices and then perform a DFT.

From Table 2 it is seen that when sample x(8) arrives it is required to somehow produce sample x(0), arrived earlier. And when sample x(9) arrives it is required to have x(1) available. Generally, when sample x(n) arrives it is required to have sample x(n−N) available (if there is any such sample). An ordinary size-N FIFO can be used, but this is tantamount to extra memory. On the other hand, as illustrated in FIG. 8 the sum of all FIFOs in a size-N DIF FFT is

$${\sum }_{s = 0}^{{log}_{2} ( N ) - 1} {D}_{s} = {\sum }_{s = 0}^{{log}_{2} ( N ) - 1} {2}^{s} = {2}^{{log}_{2} ( N )} - 1 = N - 1. \qquad ( 10 )$$

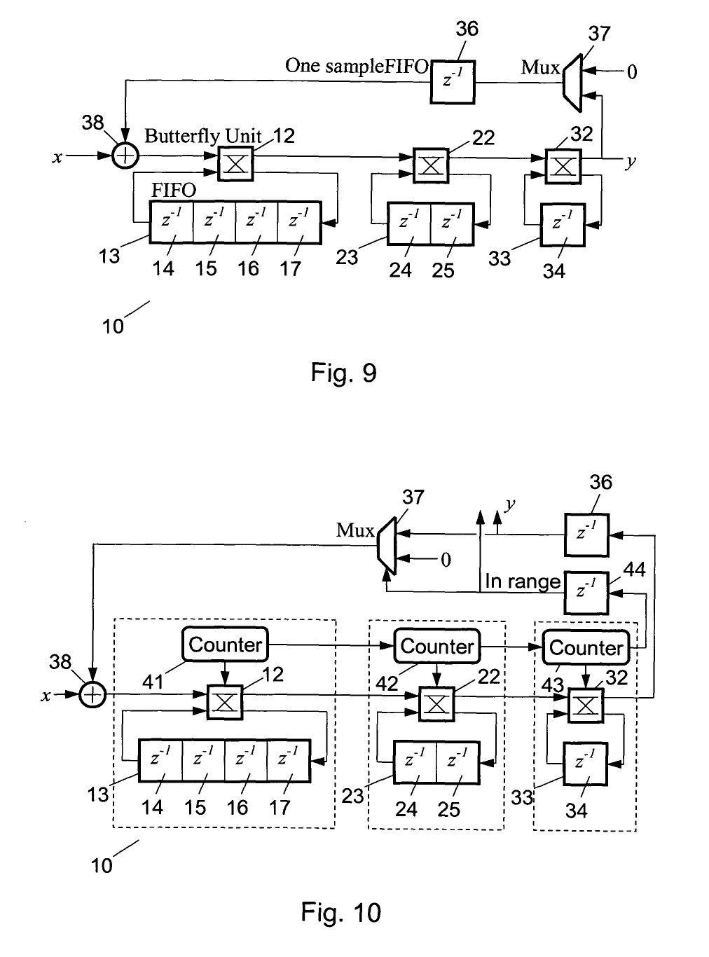

Thus, with just one extra memory element in addition to those already present in the FIFOs, it is possible to create the required delay. This is illustrated in FIG. 9 for N=8. The samples to be delayed must then pass through all the FIFOs 13, 23 and 33 in the FFT, a one sample FIFO 36, and then be fed back to the input of the FFT and added to currently arriving samples in an adder 38. This will introduce a third phase during which a stage operates in shift mode for the purpose of delaying any of the initial L−N samples. A mechanism to select whether or not samples should be fed back and added with the arriving sample is also used. A simple approach is to select in a multiplexer 37 either the output from the last FFT stage or zero as use for feedback. The described structure, depicted in FIG. 9, is henceforth called a folding pipelined DIF FFT.

The operation of a pipelined DIF FFT proceeds in cycles. In this context a cycle is only to mean that each block receives one sample on each of its inputs and produces one sample on each of its outputs. For each cycle the control signals must be set correctly for the mux 37 and the butterfly units (shift mode or computation mode, and which Twiddle Factor to use) in different stages. As long as the number of time domain samples L does not change, the values of the control signals necessarily repeat every L cycles.

Table 3 shows shift mode (o), or computation mode (x) for a non folding size-8 pipelined DIF FFT. v index the cycles within an iteration of the stage. An arrow shows when sample index 0 arrives to a given stage from the previous stage. The input index n is shown in binary notation in parenthesis. Table 3 shows how the mode for each stage is selected for a regular non folding size-8 DIF FFT during 2·8 cycles. The 8 possible samples going into a stage (0 . . . 8-1, top to bottom in FIG. 3) are indexed by v.

TABLE 3

| | | |
|---|---|---|
| Stage 2 | Stage 1 | Stage 0 |

| | | | | | | |
|---|---|---|---|---|---|---|
| n | ν | mode | ν | mode | ν | mode |

| | | | | | | | | |
|---|---|---|---|---|---|---|---|---|
| 0 (000) | 0 | o | | 4 | o | | 2 | o |
| 1 (001) | 1 | o | | 5 | o | | 3 | x |
| 2 (010) | 2 | o | | 6 | x | | 4 | o |
| 3 (011) | 3 | o | | 7 | x | | 5 | x |
| 4 (100) | 4 | x | → | 0 | o | | 6 | o |
| 5 (101) | 5 | x | | 1 | o | | 7 | x |
| 6 (110) | 6 | x | | 2 | x | → | 0 | o |
| 7 (111) | 7 | x | | 3 | x | | 1 | x |
| 0 (000) | 0 | o | | 4 | o | | 2 | o |
| 1 (001) | 1 | o | | 5 | o | | 3 | x |
| 2 (010) | 2 | o | | 6 | x | | 4 | o |
| 3 (011) | 3 | o | | 7 | x | | 5 | x |
| 4 (100) | 4 | x | → | 0 | o | | 6 | o |
| 5 (101) | 5 | x | | 1 | o | | 7 | x |
| 6 (110) | 6 | x | | 2 | x | → | 0 | o |
| 7 (111) | 7 | x | | 3 | x | | 1 | x |

The continuous set of cycles for which a stage receives all samples 0≦v<N will be called an iteration of that stage. It can be observed that the cycle in which a stage is in computation mode the first time in an iteration is the same cycle as that in which the next stage receives its sample v=0, i.e. the first cycle in an iteration of that stage. For example, the first cycle stage 2 is in computation mode (in that iteration) is when n=4, in the same cycle stage 1 receives its sample v=0. And in the same way, when n=6 stage 1 is in computation mode the first time (in that iteration) and stage 0 receives its sample v=0.

With the non folding pipelined DIF FFT there is a simple way to control the modes of the individual butterfly units by means of the index n of the arriving time domain sample. Specifically bit b in the binary representation of n can directly control stage b if 0 implies shift mode and 1 implies computation mode, as will appear from Table 3. A single binary counter is thus sufficient to set the corrected mode of all butterfly units in a non folding pipelined DIF FFT.

For a size-8 folding pipelined DIF FFT with L=13 time domain samples the correct modes for the butterfly units are given in Table 4.

Table 4 shows shift mode (o/o), or computing mode (x) for a size-8 folding pipelined DIF FFT with L=13. Mode o means that the stage is shifting in the samples to be fed back. v index the cycles within an iteration of the stage, indices N≦v<L is used for samples to be fed back. An arrow shows when sample index 0 arrives to a given stage from the previous stage. The input index n is shown in binary notation in parenthesis.

The pattern of modes for the butterfly units is the same, except that between every iteration L-N extra shift modes have been inserted. The extra L-N samples (having no counterpart in FIG. 3) have been indexed N≦v<L. Analogous with the non folding FFT, the continuous set of cycles for which a stage receives all samples 0≦v<L will be called an iteration of that stage, but it should be observed that indices N≦v<L really go together with indices 0≦v<N in the ensuing iteration.

TABLE 4

| | | Stage 2 | | | Stage 1 | | | Stage 0 | |
|---|---|---|---|---|---|---|---|---|---|
| n | | ν | mode | | ν | mode | | ν | mode |
| 0 | (0000) | (8) | o | | 4 | o | | 2 | o |
| 1 | (0001) | (9) | o | | 5 | o | | 3 | x |
| 2 | (0010) | (10) | o | | 6 | x | | 4 | o |
| 3 | (0011) | (11) | o | | 7 | x | | 5 | x |
| 4 | (0100) | (12) | o | | (8) | o | | 6 | o |
| 5 | (0101) | 0 | o | | (9) | o | | 7 | x |
| 6 | (0110) | 1 | o | | (10) | o | | (8) | o |
| 7 | (0111) | 2 | o | | (11) | o | | (9) | o |
| 8 | (1000) | 3 | o | | (12) | o | | (10) | o |
| 9 | (1001) | 4 | x | → | 0 | o | | (11) | o |
| 10 | (1010) | 5 | x | | 1 | o | | (12) | o |
| 11 | (1011) | 6 | x | | 2 | x | → | 0 | o |
| 12 | (1100) | 7 | x | | 3 | x | | 1 | x |
| 0 | (0000) | (8) | o | | 4 | o | | 2 | o |
| 1 | (0001) | (9) | o | | 5 | o | | 3 | x |
| 2 | (0010) | (10) | o | | 6 | x | | 4 | o |
| 3 | (0011) | (11) | o | | 7 | x | | 5 | x |
| 4 | (0100) | (12) | o | | (8) | o | | 6 | o |
| 5 | (0101) | 0 | o | | (9) | o | | 7 | x |
| 6 | (0110) | 1 | o | | (10) | o | | (8) | o |
| 7 | (0111) | 2 | o | | (11) | o | | (9) | o |
| 8 | (1000) | 3 | o | | (12) | o | | (10) | o |
| 9 | (1001) | 4 | x | → | 0 | o | | (11) | o |
| 10 | (1010) | 5 | x | | 1 | o | | (12) | o |
| 11 | (1011) | 6 | x | | 2 | x | → | 0 | o |
| 12 | (1100) | 7 | x | | 3 | x | | 1 | x |

While the insertion of extra shift mode cycles annihilates the simple single-counter-method to control the butterfly units, the fact that the first computation mode cycle for one stage is the same as the first cycle in the iteration of the next stage still holds. One approach, which is illustrated in FIG. 10, is to augment each stage with a separate counter corresponding to the v-index, capable of counting from 0 to L−1. Thus counters 41, 42 and 43 are shown in FIG. 10. To establish correct phases of the counters each stage asserts a signal to reset the counter in the next stage when it enters the first computation mode cycle. The mux 37 should provide zero valued feedback for those samples of stage 0 corresponding to 0≦v<N, something readily obtained by a single cycle delay 44 (to compensate for the single cycle delay 36 of the data) of a signal asserted when the counter 43 is in that range. The same signal is then also useful to tell which samples are the actual useful outputs of the FFT. FIG. 10 illustrates the basic structure of the described arrangement.

In some applications it might be desirable to multiply the time domain samples with a window (weight) function w(n) before the DFT is applied. The frequency domain samples is then

$$y ( k ) = {\sum }_{n} w ( n ) x ( n ) {W}_{N}^{kn} . \qquad ( 11 )$$

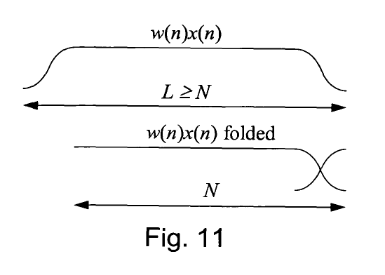

A specific application where the use of a window function might be useful is reception of OFDM signals. In this case the number of non-zero samples in the window function is L≧N, and thus the invention is directly applicable. FIG. 11 illustrates how the folding FFT processor folds the weighted time domain samples w(n)x(n) before the FFT is applied. This is also a graphical version of the folding process illustrated in Table 2. In FIG. 11, the original time domain signal x(n) is constant as to elucidate the window function w(n). As an alternative to multiplying the time domain samples, i.e. the input data values, by the window function, it is also possible that the modified or folded data values (i.e. the sum of non delayed and delayed samples) are multiplied by the window function.

It is noted that the Inverse DFT (or FFT) has the same form as the DFT (or FFT), except that the conjugate Twiddle Factor replaces the Twiddle Factor and that a scaling factor 1/N is used. Thus the computations for the IFFT are essentially the same as for the FFT, and therefore the ideas described above are also applicable for the Inverse Fourier Transforms.

Although various embodiments of the present invention have been described and shown, the invention is not restricted thereto, but may also be embodied in other ways within the scope of the subject-matter defined in the following claims.

1. (canceled)

2: A method according to claim 21, wherein said transform function is a Fast Fourier Transform.

3: A method according to claim 21, wherein said transform function is an Inverse Fast Fourier Transform.

4: A method according to claim 2, wherein said transform function is performed using a pipelined architecture in a number of serially connected stages in said circuitry, each stage comprising a butterfly unit and a number of memory elements.

5: A method according to claim 4, wherein the memory elements of each stage constitute a First In First Out buffer.

6: A method according to claim 21, wherein the method further comprises providing the modified set of data values to have the same size as the set of transformed data values.

7. (canceled)

8: A method according to claim 21, wherein the method further comprises the step of multiplying the set of input data values by a window function.

9. (canceled)

10: A device according to claim 22, wherein said transform function is a Fast Fourier Transform.

11: A device according to claim 22, wherein said transform function is an Inverse Fast Fourier Transform.

12: A device according to claim 10, wherein said circuitry for performing said transform function has a pipelined architecture with a number of serially connected stages, each stage comprising a butterfly unit and a number of memory elements.

13: A device according to claim 12, wherein the memory elements of each stage constitute a First In First Out buffer.

14: A device according to claim 22, wherein the device is arranged to provide the modified set of data values to have the same size as the set of transformed data values.

15. (canceled)

16: A device according to claim 22, wherein the device is further arranged to multiply the set of input data values by a window function.

17: A device according to claim 22, wherein the circuitry further comprises:
a number of butterfly units, each butterfly unit having at least a shift mode and a computation mode; and
a number of counters arranged such that the mode of each butterfly unit is controlled by the output of a counter.

18: A device according to claim 22, wherein the device further comprises circuitry for demodulation of Orthogonal Frequency Division Multiplexing signals.

19: A computer program comprising program code means for performing the steps of claim 21 when said computer program is run on a computer.

20: A computer readable medium having stored thereon program code means for performing the method of claim 21 when said program code means is run on a computer.

21: A method of processing a set of input data values, the method comprising the steps of:
delaying a subset of said set of input data values to obtain delayed data values;
providing a modified set of data values by adding individual delayed data values to individual non-delayed data values from said set of input data values;
performing a transform function on said modified set of data values to obtain a set of transformed data values, wherein the transform function is either a Discrete Fourier Transform or an Inverse Discrete Fourier Transform, and the number of values in the set of transformed data values is less than the number of values in the set of input data values;
providing said input data values serially to circuitry comprising a number of memory elements;
using the memory elements of said circuitry for performing the transform function; and
using the memory elements of said circuitry and one additional memory element for delaying the subset of input data values.

22: A device for processing a set of input data values, and arranged to:
delay a subset of said set of input data values to obtain delayed data values;
provide a modified set of data values by adding individual delayed data values to individual non-delayed data values from said set of input data values; and
perform a transform function on said modified set of data values to obtain a set of transformed data values, wherein the transform function is either a Discrete Fourier Transform or an Inverse Discrete Fourier Transform, and the number of values in the set of transformed data values is less than the number of values in the set of input data values,
wherein the device comprises circuitry arranged to receive said input data values serially in a number of memory elements and is further arranged to:
use the memory elements of said circuitry for performing the transform function; and
use the memory elements of said circuitry and one additional memory element for delaying the subset of input data values.
